(19) United States
(12) Patent Application Publication
(10) Pub. No.: US 2014/0222864 A1
(43) Pub. Date: Aug. 7, 2014

(54) SYSTEMS AND METHODS TO DETERMINE RELEVANT MOBILE COMPUTING DEVICE ACTIVITIES

(71) Applicant: GOOGLE INC., Mountain View, CA (US)

(72) Inventors: Michael Runge, San Mateo, CA (US); Francesco Nerieri, Santa Cruz, CA (US)

(73) Assignee: GOOGLE INC., Mountain View, CA (US)

(21) Appl. No.: 13/779,872

(22) Filed: Feb. 28, 2013

Related U.S. Application Data
(60) Provisional application No. 61/760,741, filed on Feb. 5, 2013.

(51) Int. Cl. G06F 17/30

(52) U.S. Cl. CPC G06F 17/30545
USPC 707/770; 707/769

(57) ABSTRACT

Certain implementations of the disclosed technology may include systems, methods, and apparatus for determining relevant mobile computing device activities. According to an example implementation, a method is provided for modifying a user interface based on contextual information. The method can include receiving, at a mobile computing device, identification (ID) information associated with a peripheral device, querying one or more databases to determine contextual information related to the ID information, wherein at least one of the one or more databases reside at a server, receiving, from the one or more databases, contextual information related to the ID information, associating at least one function of the mobile computing device with the contextual information, and outputting, for display on the mobile computing device, a user interface including at least a reference to the at least one function associated with the contextual information.

### RELATED APPLICATIONS

This application is related to provisional application Ser. No. 61/760,741, filed on Feb. 5, 2013, entitled: “Systems and Methods to Determine Relevant Mobile Computing Device Activities,” the contents of which are hereby incorporated by reference in their entirety.

### BACKGROUND

Mobile computing devices, such as smartphones, tablets, etc., can run a wide variety of mobile apps (mobile applications) for many specific purposes. The use of a particular app typically requires input from the user to select and launch the application. For example, when a user wishes to use a navigation app on their mobile computing device while traveling in a vehicle, he or she typically must manually search for, select, and launch the app. Searching for the desired app to launch may present a safety hazard, particularly if the user must search through numerous apps to find the navigation app. Similarly, if the user is at home and wishes to use a music application, for example, it may be inconvenient to search through numerous apps to select and launch the music application. As users continue to install a large number of mobile apps on their mobile computing devices, searching for the desired app may present challenges to the user, ranging from annoyance and inconvenience to safety issues.

### SUMMARY

Some or all of the above needs may be addressed by certain implementations of the disclosed technology. Certain implementations may include a method for associating a function of a mobile computing device with contextual information. The method may include receiving, at a mobile computing device, and from a peripheral device in communication with the mobile computing device, identification (ID) information associated with the peripheral device, and querying one or more databases to determine contextual information related to the ID information, wherein at least one of the one or more databases resides at a server. The method includes receiving, from the one or more databases, contextual information related to the ID information, associating at least one function of the mobile computing device with the contextual information, and outputting, for display on the mobile computing device, a user interface including at least a reference to the at least one function associated with the contextual information.

Certain implementations may include a method associated with a server for associating contextual information with a device identification code. The method may include storing, in a database associated with a server, a plurality of device records, each device record including a device identification (ID) code field and an associated information field, receiving, at the server, and from a mobile computing device, a query including a peripheral device ID, locating, in the database, a device record from the plurality of device records having a device ID code matching the received peripheral device ID; and transmitting at least a portion of data from the located device record information field.

Certain implementations may include non-transitory computer-readable medium that stores instructions executable by one or more processors to perform a method. The method may include receiving, at a mobile computing device, and from a peripheral device in communication with the mobile computing device, identification (ID) information associated with the peripheral device, and querying one or more databases to determine contextual information related to the ID information. The method includes receiving, from the one or more databases, contextual information related to the ID information, associating at least one function of the mobile computing device with the contextual information, and outputting, for display on the mobile computing device, a user interface including at least a reference to the at least one function associated with the contextual information.

Certain implementations may include a system. The system may include at least one memory for storing data and computer-executable instructions, and at least one processor configured to access the at least one memory. The processor may be further configured to execute the computer-executable instructions to cause the system to store, in the at least one memory, a plurality of device records, each device record including a device identification (ID) code field and an associated information field, receive a query, wherein the query includes a peripheral device ID, locate, in the at least one memory, a device record from the plurality of device records having a device ID code matching the peripheral device ID received in the query; and transmit at least a portion of data from the located device record information field.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative contextual determination system according to an example implementation.

FIG. 2A is an illustrative mobile computing device depicting a first highlighted launching application icon, based on contextual information, according to an example implementation.

FIG. 2B is an illustrative mobile computing device depicting a second highlighted launching application icon, based on contextual information, according to an example implementation.

FIG. 3 is a block diagram of an illustrative system architecture, according to an example implementation.

FIG. 4 is a flow diagram of a method according to an example implementation.

FIG. 5 is another flow diagram of a method according to an example implementation.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth herein.

In the following description, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

In some instances, a computing device may be referred to as a mobile computing device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In other instances, a computing device may be a processor, controller, or a central processing unit (CPU). In yet other instances, a computing device may be a set of hardware components.

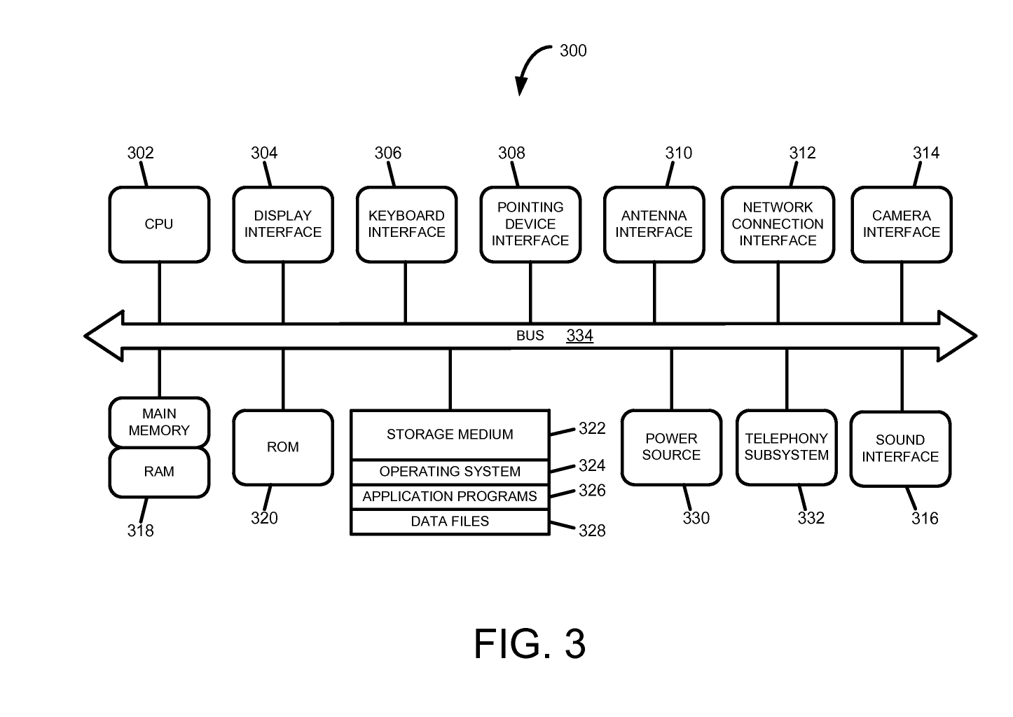

According to one example implementation, the terms computing device or mobile computing device, as used herein, may be a CPU, or conceptualized as a CPU (for example, the CPU 302 of FIG. 3). In certain example implementations, the computing device (CPU) may be coupled, connected, and/or in communication with one or more peripheral devices, such as display, navigation system, stereo, entertainment center, Wi-Fi access point, etc. In another example implementation, the term computing device or mobile computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In an example embodiment, the mobile computing device may output content to its local display and/or speaker(s). In another example implementation, the mobile computing device may output content to an external display device (e.g., over Wi-Fi) such as a TV or an external computing system.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Certain implementations of the disclosed technology may provide a context-related user interface for display using a mobile computing device. Certain implementations may simplify the selection of an application by the user based on the context in which the mobile computing device is being utilized.

Example implementations of the disclosed technology may utilize device-linking information to determine contextual information about what the user is doing while using a mobile computing device so that, for example, appropriate functions/applications may be prioritized, displayed, launched, etc. In an example implementation, when a mobile phone connects to a peripheral device (such as a car stereo, a Wi-Fi router, an information appliance, etc.,) in the user's surroundings, the connection “handshake” may discover the peripheral device brand and/or model information, and this information may provide contextual information for the user experience.

According to an example implementation of the disclosed technology, peripheral devices may link to the mobile computing device by Bluetooth, Wi-Fi, USB, DNLA, etc. In an example implementation, a Bluetooth connection to a car radio system may be utilized to provide contextual information indicating that the person is likely in a vehicle. In an example implementation, once the contextual information is determined, one or more applications on the mobile computing device may be highlighted, launched, or otherwise presented for ease of selection on the user interface of the mobile computing device.

In another example implementation, connecting to a known wireless network may provide an indication that the mobile computing device is being utilized at a certain location, and in response to the indication, one or more applications may be highlighted, launched, or placed on a prominent spot on the home screen for easy selection. For example, if the mobile computing device joins a Wi-Fi network or other peripheral device at the user's home, applications on the user's mobile computing device (that are related to activities that the user typically performs while at home) may be promoted to the home screen. In an example implementation, the handshakes to these peripheral devices may be used to help determine how the mobile phone is about to be used, and the user interface may be modified based on a known context.

In an example implementation, a server may create and keep track of a list of devices and manufacturers. The list may specify whether a device is usually used in a car, in a home, in a business, etc. For example, if the phone connects to an Airport Wi-Fi hotspot, the mobile computing device may check the received Wi-Fi identification information with the server. Information returned from the server may provide contextual information that may indicate to the mobile computing device that that the user is probably travelling, and travel-related information may be prioritized for presentation to the user.

Various implementations of the disclosed technology may be utilized for promoting and presenting applications on a mobile computing device based on peripheral device handshake context, according to example implementations of the disclosed technology, and will now be described with reference to the accompanying figures.

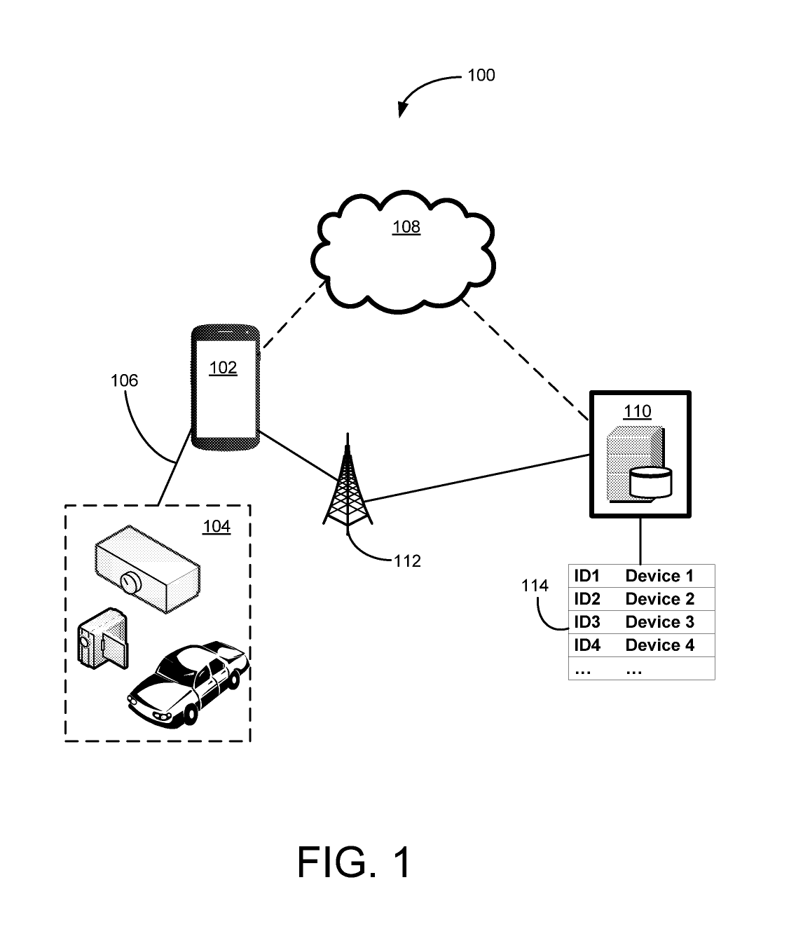

FIG. 1 illustrates a system 100 for determining contextual information related to the use of a mobile computing device 102, according to an example implementation. According to an example implementation of the disclosed technology, a mobile computing device 102 may connect (wired or wirelessly) with one or more peripheral devices 104. The peripheral devices 104, for example, may include a car stereo within an automobile, a home entertainment device, a camera, etc. According to an example implementation, the peripheral device 104, when connected to the mobile computing device 102, may provide identification (ID) information 106 to the mobile computing device 102, for example, via the communications handshake that takes place when the mobile computing device 102 is connected with the peripheral device 104.

According to certain example embodiments of the disclosed technology, Wi-Fi, Bluetooth, DNLA, and/or USB communication may be the most common standard methods for connecting the mobile computing device 102 with the peripheral device 104. Each of these connection methods may utilize a handshake that includes identification information about the peripheral device 104. According to an example implementation of the disclosed technology, the identification information 106 received from the peripheral device 104 via the handshake may be sent to a server 110 by the mobile computing device 102. According to one example embodiment, a cellular communications carrier 112 may be utilized to send the received ID information 106 to the server 110. According to another example embodiment, the Internet 108 may be utilized to send the received ID information 106 to the server 110. In one example implementation, the server 110 may reside in a remote location. In one example implementation, the server 110 may reside locally.

According to an example embodiment of the disclosed technology, the remote server 110 may include (or be in communication with) a database 114, that may store device ID and contextual information related to various peripheral devices 104. For example, the database may include identification information that matches device ID information 106 for a wide variety of peripheral devices 104. According to an example implementation, the database 114 at the remote server 110 may further include relational linkages between the device ID information 106 and contextual information, such as the probable use of the peripheral device 104. For example, the database 114 may include linked entries that may specify the environment, for which the peripheral device 104 is designed for use. Such contextual information, derived from the device ID 106, may be retrieved by the mobile computing device 102 from the remote server 110, and the mobile computing device 102 may utilize such information to present, launch, and/or highlight an appropriate mobile application at the user interface of the mobile computing device 102.

According to certain example implementations, a database 114 at the remote server 110 may include a list of devices and manufacturers, and associated device handshake ID information. In one example embodiment, the list may specify whether a device is usually used in a car, in a home, or in a business. For example, part of the MAC address of a wireless device may indicate the manufacturer and product identification. For Bluetooth, the name of the device is provided as part of the pairing process for connecting two devices. In an example implementation, the system 100 may be utilized to determine that the mobile computing device 104 is in a car for example, when the mobile computing device 104 is connected over Bluetooth to the car's audio system. According to certain example implementations, audio systems produced by certain manufacturers may have a similar device names that specified in the handshake, and when the pairing takes place, the system 100 may compare the device name to the list of know devices in the database 114.

According to another example implementation, peripheral device names or ID information may be stored locally on the mobile computing device 102, and may be utilized for determination of the context for use of the mobile computing device 102. In this embodiment, the communication with the remote server 110 may be unnecessary, particularly if the mobile computing device 102 has previously paired with the peripheral device 104 and such pairing is already known and trusted.

According to an example implementation of the disclosed technology, once the contextual information has been determined, for example, by the pairing and by the retrieval of the contextual information (based on the pairing), the mobile computing device 102 may present an appropriate user interface for enhanced ease of selection of the appropriate application.

In one example implementation, voice control interaction with a mobile phone may be based on whether or not it is in a car. For example, when system 100 determines that the mobile computing device 104 is in a car, the voice command may default to control of a map or navigation application. In another implementation, when the system 100 determines that the mobile computing device 102 is in proximity to a home theater systems, for example by virtue of connecting with a home Wi-Fi network, the mobile computing device 102 may display apps that control aspects of the home theater. In another example implementation, when the system 100 connects with a home Wi-Fi network, certain advertisements may be presented via the browser that are home-user focused. In another example implementation, when the system 100 connects with a work Wi-Fi network, business focused advertisements may be presented.

According to an example implementation of the disclosed technology, location information may be utilized by the system 100 to modify the user's interaction with the mobile computing device 102. For example, if the user appears to be away from home and work by a long distance, relevant advertisements could be presented. In another example implementation, if the phone connects to an Airport Wi-Fi hotspot, the system 100 could determine that the person may be travelling and targeted travel information may be provided.

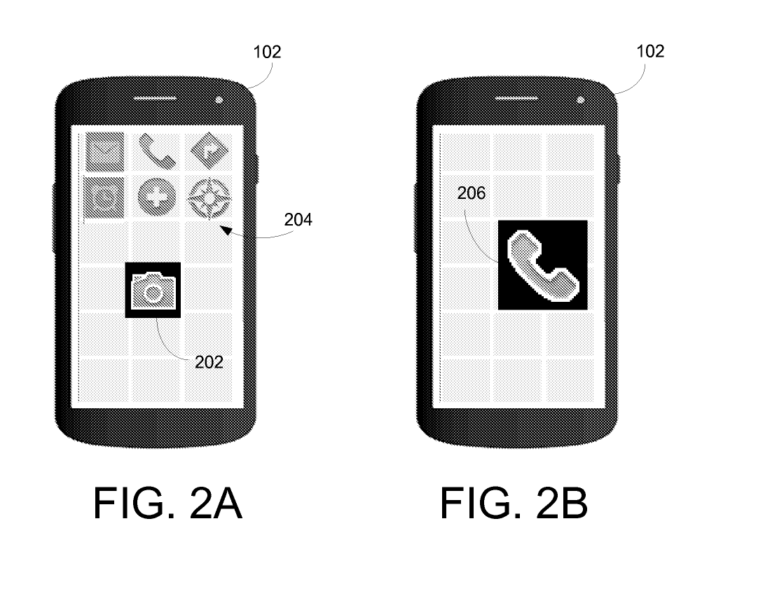

FIG. 2A depicts an illustrative mobile computing device 102 in the form of a mobile phone (or smartphone) having an application icon selection screen 204 with various application icons. In an example implementation of the disclosed technology, based on determined contextual information (as described above), a first application icon 202 may be displayed on the icon selection screen 204 in a prominent position for ease of selection by the user. In another example implementation, the first application icon 202 may be highlighted to distinguish it from the other application icons. In yet another example implementation, the mobile application associated with the first application icon 202 may be launched in response to the determined contextual information. In this example implementation, the first application icon 202, as shown, depicts a camera that, for example, may be connected to be mobile computing device 102 via a handshake, and based on the information exchanged in the handshake, the system 100 may determine that the photo application is appropriate for the context of the situation.

FIG. 2B is an illustrative mobile computing device 102 form of a mobile phone (or smartphone) depicting a second application icon 206, that may be prominently displayed on its own user interface screen, based on contextual information, according to an example implementation of the disclosed technology. In this example illustrative implementation, the phone icon may be presented on the user interface in response to determined contextual information associated with activities related to telephonic communications. According to an example implementation of the disclosed technology, the second application icon 206 may be associated with a navigation application on the mobile computing device 102. For example, if a user enters her vehicle, the mobile computing device 102 may wirelessly handshake with the car stereo, and based on the identification information exchanged during the handshake, the system 100 may identify the peripheral device, as being a car stereo and based on this information, a navigation and/or a stereo control icon may be prominently displayed for selection by the user.

The example embodiments shown in FIG. 2A and FIG. 2B illustrate just a small subset of the types of user interface display configurations that may be presented to the user in response to the determination of contextual information based on proximity of the user to a particular peripheral device and the information exchanged in the connection handshake. These example embodiments shown are not meant to limit the scope of the claimed technology, but are shown for illustrative purposes.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

FIG. 3 depicts a block diagram of an illustrative computer system architecture 300 according to an example implementation. Certain aspects of FIG. 3 may be embodied in the mobile computing device (for example, the mobile computing device 102 as shown in FIGS. 1A, 2A and 2B). Certain aspects of FIG. 3 may be embodied in the remote server (for example, the remote server 110 as shown in FIG. 1). Various implementations and methods herein may be embodied in non-transitory computer readable media for execution by a processor. It will be understood that the architecture 300 is provided for example purposes only and does not limit the scope of the various implementations of the communication systems and methods.

The architecture 300 of FIG. 3 includes a central processing unit (CPU) 302, where computer instructions are processed; a display interface 304 that acts as a communication interface and provides functions for rendering video, graphics, images, and texts on the display. In certain example implementations of the disclosed technology, the display interface 304 may be directly connected to a local display, such as a touch-screen display associated with a mobile computing device. In another example implementation, the display interface 304 may be configured for providing data, images, and other information for an external/remote display that is not necessarily connected to the mobile computing device. For example, a desktop monitor may be utilized for mirroring graphics and other information that is presented on a mobile computing device. In certain example implementations, the display interface 304 may wirelessly communicate, for example, via a Wi-Fi channel or other available network connection interface 312 to the external/remote display.

In an example implementation, the network connection interface 312 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 304 may be operatively coupled to a local display, such as a touch-screen display associated with a mobile computing device. In another example, the display interface 304 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile computing device. In another example, the display interface 304 may wirelessly communicate, for example, via the network connection interface 312 such as a Wi-Fi transceiver to the external/remote display.

The architecture 300 may include a keyboard interface 306 that provides a communication interface to a keyboard; and a pointing device interface 308 that provides a communication interface to a pointing device or touch screen. Example implementations of the architecture 300 may include an antenna interface 310 that provides a communication interface to an antenna; a network connection interface 312 that provides a communication interface to a network. As mentioned above, the display interface 304 may be in communication with the network connection interface 312, for example, to provide information for display on a remote display that is not directly connected or attached to the system. In certain implementations, a camera interface 314 may be provided that may act as a communication interface and/or provide functions for capturing digital images from a camera. In certain implementations, a sound interface 316 is provided as a communication interface for converting sound into electrical signals using a microphone and for converting electrical signals into sound using a speaker. According to example implementations, a random access memory (RAM) 318 is provided, where computer instructions and data may be stored in a volatile memory device for processing by the CPU 302.

According to an example implementation, the architecture 300 includes a read-only memory (ROM) 320 where invariant low-level system code or data for basic system functions such as basic input and output (I/O), startup, or reception of keystrokes from a keyboard are stored in a non-volatile memory device. According to an example implementation, the architecture 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an example implementation, the architecture 300 includes a power source 330 that provides an appropriate alternating current (AC) or direct current (DC) to power components. According to an example implementation, the architecture 300 includes and a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data may be stored in the RAM 318, where the data may be accessed by the computer CPU 302 during execution. In one example configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

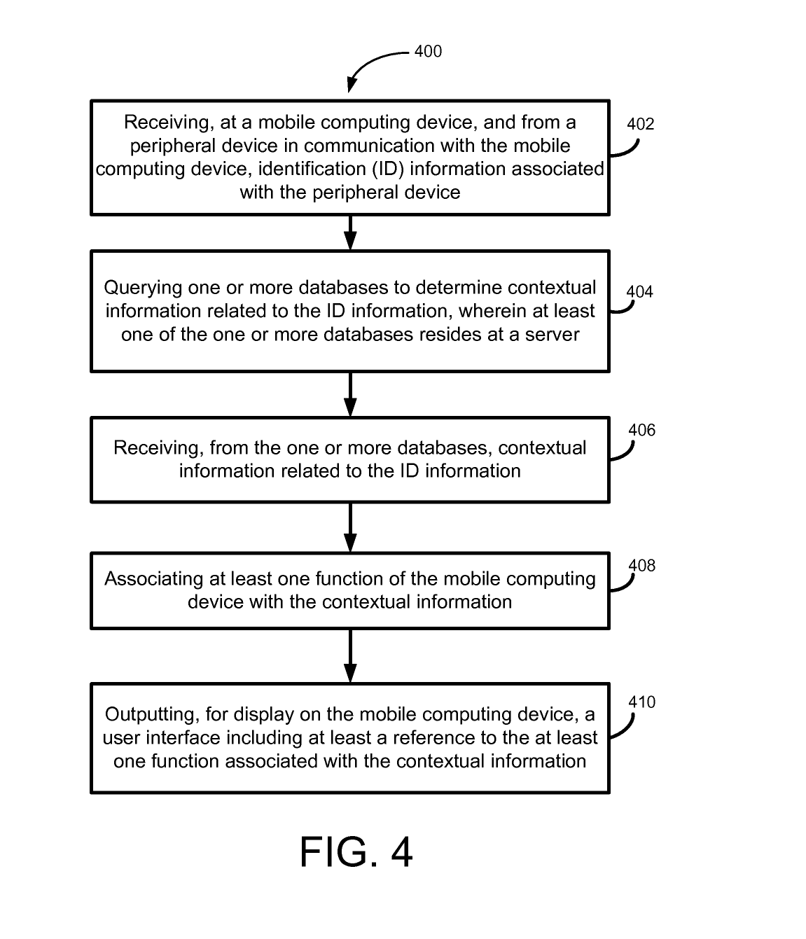

FIG. 4 depicts a method 400, according to an example implementation of the disclosed technology. In block 402, the method 400 includes receiving, at a mobile computing device, and from a peripheral device in communication with the mobile computing device, identification (ID) information associated with a peripheral device. In block 404, the method 400 includes querying a database to determine contextual information related to the ID information, wherein at least one of the one or more databases resides at a remote server. In block 406. The method 400 includes receiving, from the database, contextual information related to the ID information. In block 408, the method 400 includes associating at least one function of the mobile computing device with the contextual information. In block 410. The method 400 includes outputting, for display on the mobile computing device, a user interface including at least a reference to the at least one function associated with the contextual information.

According to an example implementation, the peripheral device is located in a same physical environment as the mobile computing device. In one example implementation, at least one of the one or more databases resides locally on the mobile computing device. An example implementation includes querying the one or more databases, which includes sending the received ID information to the remote server, wherein the remote server is configured to determine contextual information from the ID information, and where the contextual information is sent back from the remote server to the querying mobile computing device. According to an example implementation, the contextual information includes an activity the user is performing. An example implementation may further include determining location information associated with the mobile computing device, and may include outputting, for display on the mobile computing device, a user interface including at least a reference to the at least one function associated with the location information. According to one example implementation, receiving the identification (ID) information associated with a peripheral device includes receiving the information by a wireless communications channel.

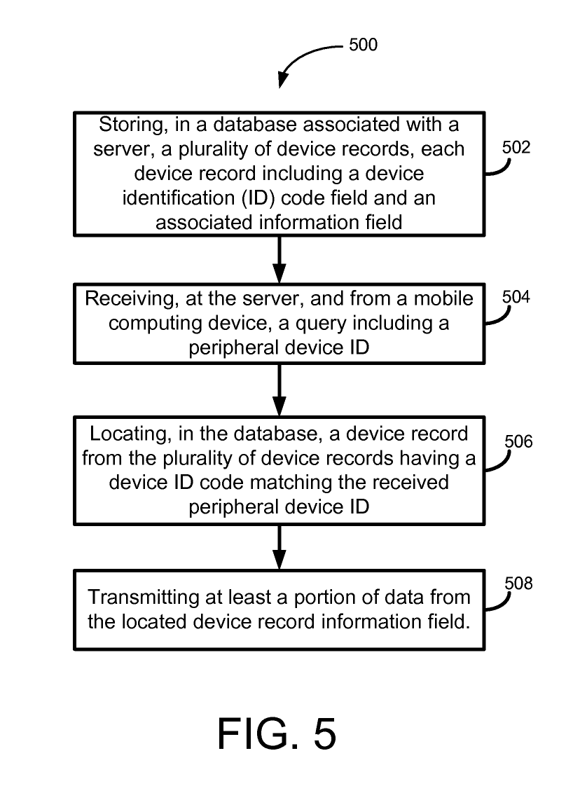

Another example method 500 will now be described with reference to the flowchart of FIG. 5. The method 500 starts in block 502, and according to an example implementation includes storing, in a database associated with a server, a plurality of device records, each device record including a device identification (ID) code field and an associated information field. In block 504, the method 500 includes receiving, at the server, and from a mobile computing device, a query including a peripheral device ID. In block 506, the method 500 includes locating, in the database, a device record from the plurality of device records having a device ID code matching the received peripheral device ID. In block 508, the method 500 includes transmitting at least a portion of data from the located device record information field.

According to example implementations, certain technical effects can be provided, such as creating certain systems and methods that provide an enhanced user experience for interaction with a mobile computing device based on determined contextual information about the use of the mobile computing device. Example implementations of the disclosed technology can provide the further technical effects of providing systems and methods for highlighting or prominently displaying an appropriate application selection icon on a mobile computing device based on handshake information exchanged during connection with a peripheral device.

In example implementations of the disclosed technology, the system 100 may include any number of hardware and/or software applications that are executed to facilitate any of the operations. In example implementations, one or more I/O interfaces may facilitate communication between the system 100 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the system 100. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the system 100 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a DLNA enabled network, a USB connection, a satellite-based network any wired network, any wireless network, etc., for communication with external devices and/or systems.

As desired, implementations of the disclosed technology may include the system 100 with more or less of the components illustrated in FIG. 1.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile computing devices, generally known as portable computing devices that can run on batteries but are not usually classified as laptops. For example, mobile computing devices can include, but are not limited to portable computers, tablet PCs, Internet tablets, PDAs, ultra mobile PCs (UMPCs) and smartphones.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
receiving, at a mobile computing device, and from a peripheral device located in a same physical environment as the mobile computing device and in communication with the mobile computing device, peripheral device identification (ID) information;
querying a server database to determine a contextual information usage profile related to the ID information, the server database comprising identification information and associated contextual information usage profiles for a plurality of peripheral devices;
receiving, from the server database, the contextual information usage profile related to the ID information;
associating at least one function or application of the mobile computing device with the contextual information usage profile; and
automatically outputting for display, responsive to the associating, a reference to the at least one function or application associated with the contextual information usage profile.

2. The method of claim 1, wherein outputting, for display, comprises outputting an icon corresponding to the at least one function or application on a home screen of the mobile computing device.

3. The method of claim 1, further comprising querying a local database to determine the contextual information usage profile related to the ID information, wherein the local database resides on the mobile computing device.

4. The method of claim 1, wherein querying the server database comprises sending the received ID information to a remote server, wherein the remote server is configured to determine the contextual information usage profile from the ID information, and where the contextual information usage profile is sent back from the remote server to the querying mobile computing device.

5. The method of claim 1, wherein the contextual information usage profile includes one or more of an activity and a probable usage.

6. The method of claim 1, further comprising:
determining location information associated with the mobile computing device; and
outputting, for display, a user interface including at least a reference to the at least one function associated with the location information.

7. The method of claim 1, wherein receiving the identification (ID) information associated with a peripheral device comprises receiving the information by a wireless communications channel.

8. A computer-implemented method comprising:
storing, in a database associated with a server, a plurality of device records, each device record including a device identification (ID) code field and an associated information field;
receiving, at the server, and from a mobile computing device, a query including a peripheral device ID;
locating, in the database, a device record from the plurality of device records having a device ID code matching the received peripheral device ID; and
transmitting at least a portion of data from the located device record information field

9. The method of claim 8, wherein each device record corresponds to information associated with a peripheral device, wherein the peripheral device is configured to communicate wirelessly with the mobile computing device.

10. The method of claim 9, wherein the peripheral device is located in a same physical environment as the mobile computing device.

11. The method of claim 8, wherein the associated information field includes contextual information associated with the device record.

12. The method of claim 11, wherein the contextual information includes usage information associated a peripheral device, wherein the usage information includes one or more of location, home use, work use, automobile use, or public use.

13. The method of claim 8, wherein transmitting includes sending at least a portion of data from the located device record information field to the mobile computing device.

14. A non-transitory computer-readable medium that stores instructions executable by one or more processors to perform a method comprising:
receiving, at a mobile computing device, and from a peripheral device located in a same physical environment as the mobile computing device and in communication with the mobile computing device, peripheral device identification (ID) information;
querying a server database to determine a contextual information usage profile related to the ID information, the server database comprising identification information and associated contextual information usage profiles for a plurality of peripheral devices;
receiving, from the server database, the contextual information usage profile related to the ID information;
associating at least one function or application of the mobile computing device with the contextual information usage profile; and
automatically outputting for display, responsive to the associating, a reference to at least one function or application associated with the contextual information user profile.

15. The non-transitory computer readable medium of claim 14, wherein outputting, for display, comprises outputting an icon corresponding to the at least one function or application on a home screen of the mobile computing device.

16. The non-transitory computer-readable medium of claim 14, further comprising querying a local database to determine the contextual information usage profile related to the ID information, wherein the local database resides on the mobile computing device.

17. The non-transitory computer-readable medium of claim 14, wherein querying the server database comprises sending the received ID information to a remote server, wherein the remote server is configured to determine the contextual information usage profile from the ID information, and where the contextual information usage profile is sent back from the remote server to the querying mobile computing device.

18. The non-transitory computer-readable medium of claim 14, wherein the contextual information usage profile includes one or more of an activity and a probable usage.

19. The non-transitory computer-readable medium of claim 14, further comprising:
determining location information associated with the mobile computing device; and
outputting, for display, a user interface including at least a reference to the at least one function associated with the location information.

20. The non-transitory computer-readable medium of claim 14, wherein receiving the identification (ID) information associated with a peripheral device comprises receiving the information by a wireless communications channel.

21. A system comprising:
at least one memory for storing data and computer-executable instructions; and
at least one processor configured to access the at least one memory and further configured to execute the computer-executable instructions to cause the system to:
store, in the at least one memory, a plurality of device records, each device record including a device identification (ID) code field and an associated information field;
receive a query, wherein the query includes a peripheral device ID;
locate, in the at least one memory, a device record from the plurality of device records having a device ID code matching the peripheral device ID received in the query; and
transmit at least a portion of data from the located device record information field.

22. The system of claim 21, wherein each device record corresponds to information associated with a peripheral device, wherein the peripheral device is configured to communicate wirelessly with a mobile computing device, and wherein the query is received from the mobile computing device.

23. The system of claim 22, wherein the peripheral device is located in a same physical environment as the mobile computing device.

24. The system of claim 21, wherein the associated information field includes contextual information associated with the device record.

25. The method of claim 24, wherein the contextual information includes usage information associated a peripheral device, wherein the usage information includes one or more of location, home use, work use, automobile use, or public use.

26. The method of claim 21, wherein transmitting includes sending at least a portion of data from the located device record information field to the mobile computing device.
